(19) United States
(12) Patent Application Publication
(10) Pub. No.: US 2012/0169272 A1
(43) Pub. Date: Jul. 5, 2012

(54) PORTABLE USB MINI-CHARGER DEVICE

(76) Inventor: David Khalepari, Hidden Hills, CA (US)

(21) Appl. No.: 12/983,381

(22) Filed: Jan. 3, 2011

(51) Int. Cl. H02J 7/00

(52) U.S. Cl. 320/107

(57) ABSTRACT

The present invention is comprised of a portable USB mini-charger device to easily connect portable electronic devices to readily available power sources to operate or recharge internal rechargeable batteries. The present invention is further comprised of components to increase the number of easily accessible electrical connections to allow a greater number of portable electronic devices to be powered by a USB connection. The present invention provides adaptability to connect to either a DC or AC current power source further increasing the number of readily available power sources to maintain the portability and mobility characteristics inherent in portable electronic devices.

### BACKGROUND

The proliferation of electronic devices over the past decades has led to many portable devices for communication, computation, viewing and listening to media of all types and many other types for a multitude of purposes. A growing number of the portable electronic devices draw electrical power from USB connections to other digital or electronic equipment such as desk top computers. Many of these portable electronic devices have internal rechargeable batteries in order to operate in a portable or mobile manner. The ability to draw electrical power using USB connections from any readily available power source has become essential to maintaining true portability.

### BRIEF DESCRIPTION OF THE DRAWINGS

FIG. 1 shows a block diagram of an overview of a portable USB mini-charger device of one embodiment of the present invention.

FIG. 2 shows a block diagram of an overview flow chart of a portable USB mini-charger device operation of one embodiment of the present invention.

FIG. 3 shows a block diagram of an overview flow chart of a portable USB mini-charger device multi-hub adapter operation of one embodiment of the present invention.

FIG. 4A shows for illustrative purposes only an example of a portable USB mini-charger DC device from a USB receptacle end view of one embodiment of the present invention.

FIG. 4B shows for illustrative purposes only an example of a portable USB mini-charger DC device from a 12 volt cigarette lighter plug end view of one embodiment of the present invention.

FIG. 4C shows for illustrative purposes only an example of a portable USB mini-charger DC device from a spring side view of one embodiment of the present invention.

FIG. 4D shows for illustrative purposes only an example of a portable USB mini-charger DC device from a spring profile side view of one embodiment of the present invention.

FIG. 4E shows for illustrative purposes only an example of a portable USB mini-charger DC device in a prospective view of one embodiment of the present invention.

FIG. 5A shows for illustrative purposes only an example of a portable USB mini-charger AC device in an outlet blade extended end view of one embodiment of the present invention.

FIG. 5B shows for illustrative purposes only an example of a portable USB mini-charger AC device in a USB receptacle end view of one embodiment of the present invention.

FIG. 5C shows for illustrative purposes only an example of a portable USB mini-charger AC device in a bottom view of one embodiment of the present invention.

FIG. 5D shows for illustrative purposes only an example of a portable USB mini-charger AC device hinged outlet blade operation in a side view of one embodiment of the present invention.

FIG. 5E shows for illustrative purposes only an example of a portable USB mini-charger AC device in a prospective view of one embodiment of the present invention.

FIG. 6A shows for illustrative purposes only an example of a portable USB mini-charger device multi-hub adapter from a USB plug end view of one embodiment of the present invention.

FIG. 6B shows for illustrative purposes only an example of a portable USB mini-charger device multi-hub adapter from a USB receptacle end view of one embodiment of the present invention.

FIG. 6C shows for illustrative purposes only an example of a portable USB mini-charger device multi-hub adapter in a prospective view of one embodiment of the present invention.

FIG. 6D shows for illustrative purposes only an example of a portable USB mini-charger DC device and a multi-hub adapter connection operation from a side view of one embodiment of the present invention.

FIG. 7A shows for illustrative purposes only an example of a portable USB mini-charger AC two USB port device font view of one embodiment of the present invention.

FIG. 7B shows for illustrative purposes only an example of a portable USB mini-charger AC two USB port device back prospective view of one embodiment of the present invention.

FIG. 7C shows for illustrative purposes only an example of a portable USB mini-charger AC two USB port device right side prospective view of one embodiment of the present invention.

FIG. 8A shows for illustrative purposes only an example of a portable USB mini charger AC device hinged pin plug type in a front USB prospective view of one embodiment of the present invention.

FIG. 8B shows for illustrative purposes only an example of a portable USB mini charger AC device hinged pin plug type in a back hinged pin plug prospective view of one embodiment of the present invention.

FIG. 8C shows for illustrative purposes only an example of a portable USB mini charger AC device hinged pin plug type adapter in a prospective view of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a portable USB mini-charger device is described for illustrative purposes and the underlying method can apply to any number and multiple types of portable USB mini-charger devices. In one embodiment of the present invention, the portable USB mini-charger device is configured to connect to a DC voltage source. In another embodiment the portable USB mini-charger device is configured to connect to an AC voltage source and portable USB mini-charger devices can be configured using multiple types of receptacles, plugs and fabricated using various plastics and components or created in other forms, colors, shapes, sizes and depictions using the present invention.

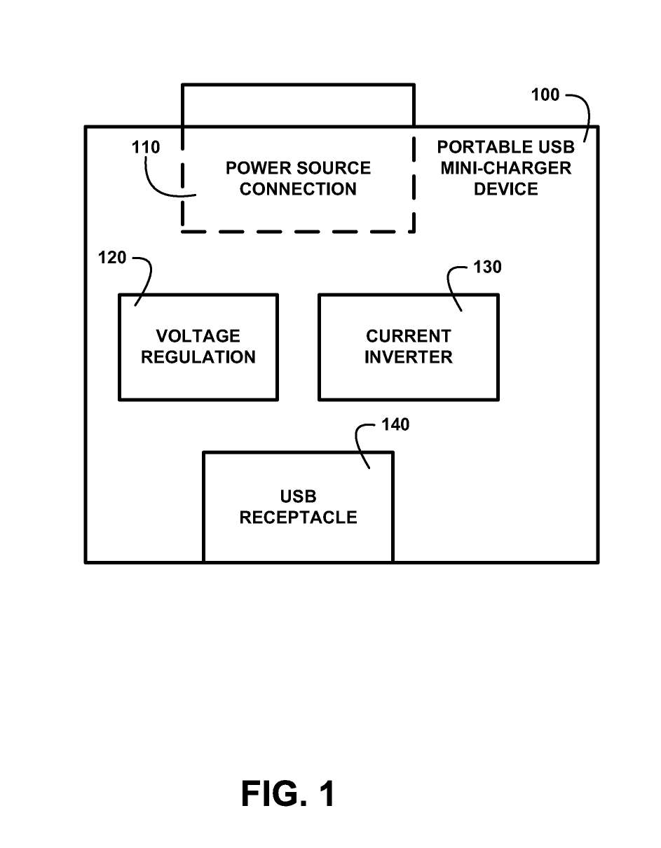

FIG. 1 shows a block diagram of an overview of a portable USB mini-charger device of one embodiment of the present invention. FIG. 1 shows a portable USB mini-charger device 100 which can be configured to connect to either a DC or AC voltage power source with a power source connection 110. The power source connection 110 can be configured to connect into a vehicle 12 volt DC current electrical supply through the cigarette lighter receptacle. The power source connection 110 can be configured to connect into a 120 volt AC current outlet through hinged plug blades that fold into recesses for easy storage. The portable USB mini-charger device 100 configured for connection to a 120 volt AC current outlet includes a current inverter 130 to convert the AC current to a DC current. The portable USB mini-charger device 100 is configured to include a voltage regulation 120 system to control the DC voltage level to create a compatible supply of electricity to portable electronic devices of one embodiment of the present invention.

The portable USB mini-charger device 100 is configured to include a USB receptacle 140 to allow portable electronic devices to draw power from the USB receptacle 140 using a connecting cable with a USB plug. The portable USB mini-charger device 100 can be configured to include a multi-hub adapter equipped with a USB plug to connect to the USB receptacle 140 of the portable USB mini-charger device 100 to provide two or more USB receptacles for use with portable electronic devices. The portable USB mini-charger device 100 provides electrical power using USB connections from any available power source to maintain true portability for operating and recharging internal batteries of portable electronic devices for example digital media players, iPods, PDA's, cell phones, digital cameras, laptop and tablet computers and portable televisions of one embodiment of the present invention.

### Detailed Operation:

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

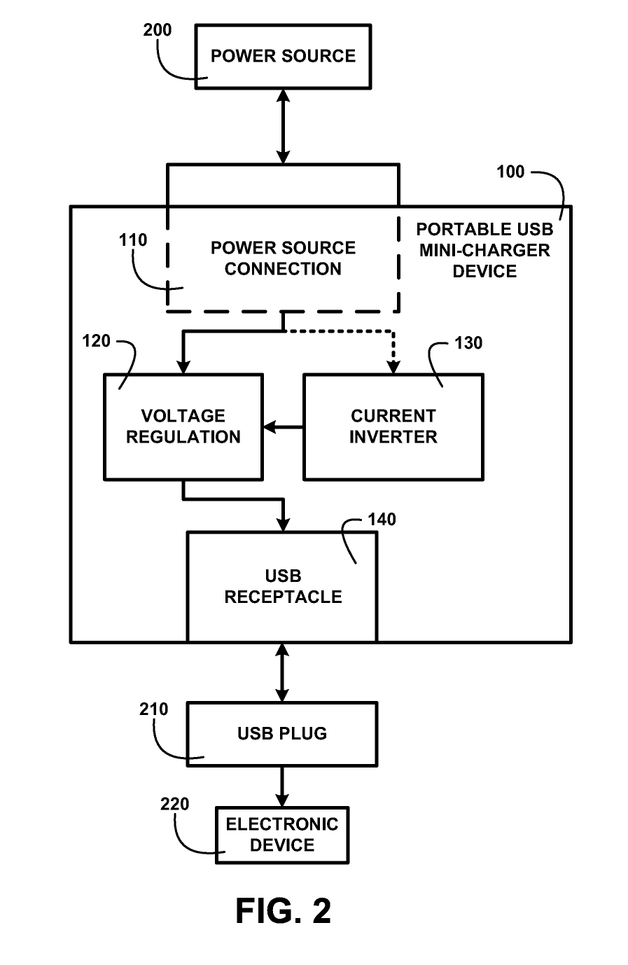

FIG. 2 shows a block diagram of an overview flow chart of a portable USB mini-charger device operation of one embodiment of the present invention. FIG. 2 shows a portable USB mini-charger device 100 connecting to either a DC or AC voltage power source 200 with a power source connection 110 configured to connect to a readily available DC or AC voltage power source 200. The power source connection 110 can be configured to connect into a vehicle 12 volt DC current electrical supply through the cigarette lighter receptacle. The power source connection 110 can be configured using hinged outlet plug blades to connect into a 120 volt AC current outlet power source 200. The AC current flowing from the 120 volt AC current outlet power source 200 is configured to pass through the current inverter 130 to convert the AC current to a DC current. The DC current flowing from the current inverter 130 or from the power source connection 110 configured to connect into a vehicle 12 volt DC current electrical supply is configured to pass through the voltage regulation 120 system to control the DC voltage level to create a compatible supply of electricity to portable electronic devices of one embodiment of the present invention.

The portable USB mini-charger device 100 is configured to allow a portable electronic device 220 to draw power from the USB receptacle 140 using a connecting cable with a USB plug 210. The USB receptacle 140 can be configured to different types of USB connector receptacles such as Standard-A, Standard-B, Mini-A, Mini-B, Micro-A and Micro-B. The ability to configure the power source connection 110 of the portable USB mini-charger device 100 for both an AC and a DC current provides an increase in power source 200 connections readily available for the user of an electronic device 220. The adaptability to configure the USB receptacle 140 of the portable USB mini-charger device 100 as different types of USB connections allows the user to draw power an electronic device 220 more easily for operating and recharging the internal batteries of a wide selection of portable devices such as digital media players, cell phones, digital cameras, laptop and tablet computers and portable televisions of one embodiment of the present invention.

### Multi-Hub Adapter:

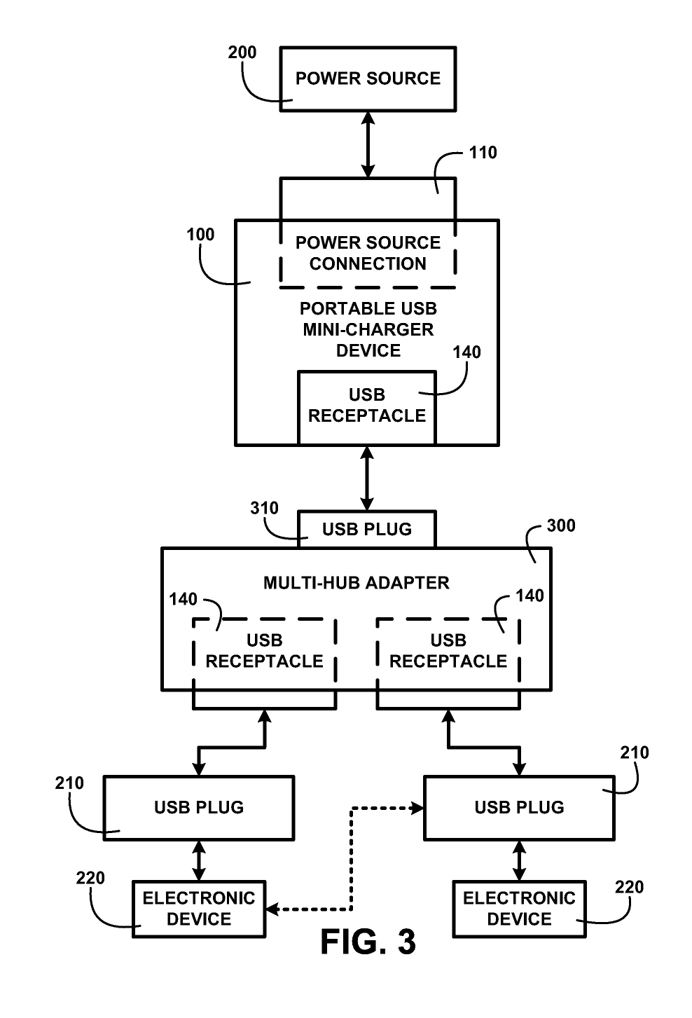

FIG. 3 shows a block diagram of an overview flow chart of a portable USB mini-charger device multi-hub adapter operation of one embodiment of the present invention. FIG. 3 shows the portable USB mini-charger device 100 connected to the power source 200 using the power source connection 110. The electrical current is flowing from the power source 200 through the portable USB mini-charger device 100 to the USB receptacle 140. A multi-hub adapter 300 portable USB mini-charger device 100 component is connected to the portable USB mini-charger device 100 using a multi-hub adapter USB plug 310 inserted into the USB receptacle 140 of the portable USB mini-charger device 100 of one embodiment of the present invention.

The multi-hub adapter 300 component is configured to split the electrical current flowing from the USB receptacle 140. The multi-hub adapter 300 component is configured to include two or more USB receptacle 140 connections to continue the split flow of current. One electronic device 220 using two or more USB connection powered elements can connect to the multi-hub adapter 300 component using multiple cables configured with a USB plug 210 connection. More than one USB connection powered electronic device 220 can be operated or perform an internal battery recharging operation using separate cables configured with a USB plug 210 connection inserted into the multiple USB receptacle 140 connections of the multi-hub adapter 300 component of the portable USB mini-charger device 100 of one embodiment of the present invention.

### Portable USB Mini-Charger DC Device:

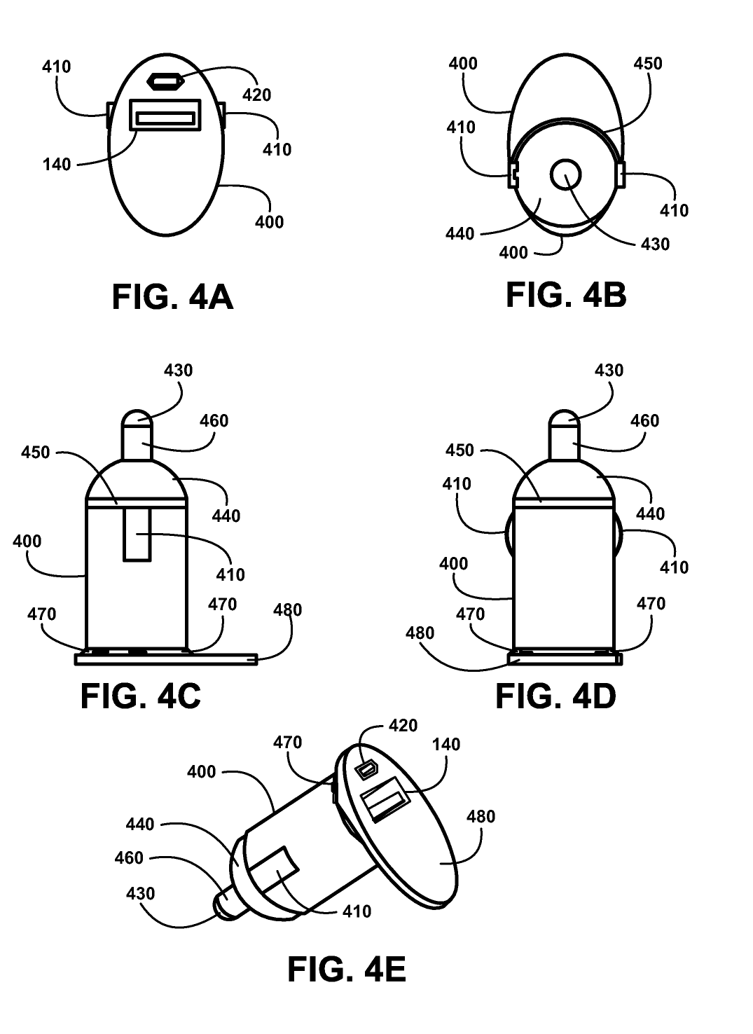

The portable USB mini-charger DC device can be fabricated in various configurations using different components and oriented in differing positions. FIG. 4A, FIG. 4B, FIG. 4C, FIG. 4D and FIG. 4D shows for illustrative purposes only various views of one example of a portable USB mini-charger DC device configuration of one embodiment of the present invention.

FIG. 4A shows for illustrative purposes only an example of a portable USB mini-charger DC device from a USB receptacle end view of one embodiment of the present invention. FIG. 4A shows the portable USB mini-charger device 100 of FIG. 1 configured to include the power source connection 110 of FIG. 1 for connection to a DC current power source 200 of FIG. 2 to create a portable USB mini-charger DC device 400 configured to include the voltage regulation 120 system of FIG. 1. The power source connection 110 of FIG. 1 of the portable USB mini-charger DC device 400 is configured as a vehicle 12 volt cigarette lighter plug. A spring 410 is positioned on two opposing sides of the portable USB mini-charger DC device 400 plug configuration to secure the plug configuration in a vehicle 12 volt cigarette lighter receptacle by the force of one or more spring against the interior side surfaces of the receptacle socket. A power indicator light 420 is configured to turn on when the DC current connection is completed of one embodiment of the present invention.

FIG. 4B shows for illustrative purposes only an example of a portable USB mini-charger DC device from a 12 volt cigarette lighter plug end view of one embodiment of the present invention. FIG. 4B shows the portable USB mini-charger DC device 400 configured to include the two opposing spring 410 elements. A contact 430 is used to make an electrical connection to the vehicle 12 volt cigarette lighter electrical system power source 200 of FIG. 2. A plug insertion guide 440 directs the insertion of the portable USB mini-charger DC device 400 into the vehicle 12 volt cigarette lighter receptacle and an insulating gasket 450 prevents the electrical DC current from being conducted due to contamination inside the vehicle 12 volt cigarette lighter receptacle socket view of one embodiment of the present invention.

FIG. 4C shows for illustrative purposes only an example of a portable USB mini-charger DC device from a spring side view of one embodiment of the present invention. FIG. 4C shows the portable USB mini-charger DC device 400 configured to include the spring 410 elements and contact 430 to make a connection to the vehicle 12 volt cigarette lighter electrical system power source 200 of FIG. 2. The curved profile of the plug insertion guide 440 makes the insertion into the DC receptacle easier to perform. The insulating gasket 450 is positioned to prevent a short circuit between the contact 430 and the spring 410 elements of one embodiment of the present invention.

The portable USB mini-charger DC device 400 is configured to include a USB receptacle DC face plate 480 to mount the USB receptacle 140 of FIG. 1. The USB receptacle DC face plate 480 is configured to include an insulating air gap 470 created by positioning multiple insulated contact support 460 elements between the body of the portable USB mini-charger DC device 400 12 volt DC plug and the USB receptacle DC face plate 480 of one embodiment of the present invention.

FIG. 4D shows for illustrative purposes only an example of a portable USB mini-charger DC device from a spring profile side view of one embodiment of the present invention. FIG. 4D shows the portable USB mini-charger DC device 400 configured to include the contact 430, the plug insertion guide 440, the insulating gasket 450, the multiple insulated contact support 460, the insulated air gap 470 and the USB receptacle DC face plate 480. The spring 410 elements are shown in profile to indicate the curved feature of the tensioned spring 410 installation. The tensioned orientation creates the spring 410 force used to secure the portable USB mini-charger DC device 400 after insertion into the vehicle 12 volt cigarette lighter receptacle socket view of one embodiment of the present invention.

FIG. 4E shows for illustrative purposes only an example of a portable USB mini-charger DC device in a prospective view of one embodiment of the present invention. FIG. 4E shows the portable USB mini-charger DC device 400 configured to include the spring 410, the contact 430, the plug insertion guide 440, the insulating gasket 450 and the insulated contact support 460. The prospective view illustration of this example clearly shows the relationship of the elements of the portable USB mini-charger DC device 400 including the USB receptacle DC face plate 480, the power indicator light 420 and the USB receptacle 140. It demonstrates the easy access to connect a USB connection powered electronic device 220 to the USB receptacle 140 of one embodiment of the present invention.

### Portable USB Mini-Charger AC Device:

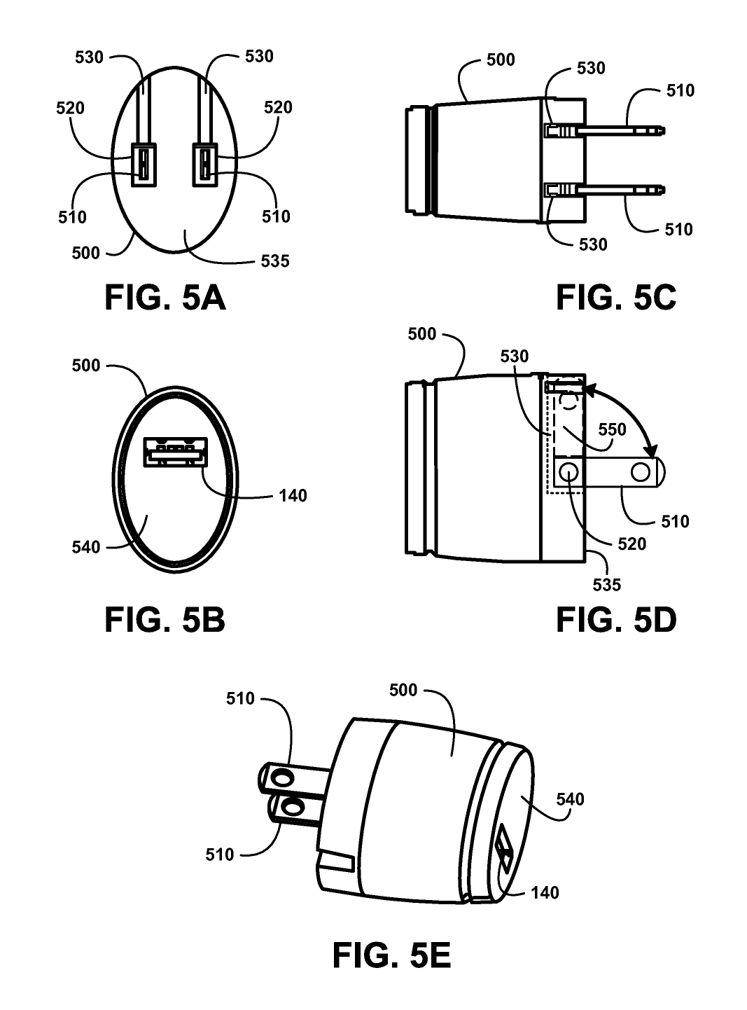

The portable USB mini-charger AC device can be fabricated in various configurations using different components and oriented in differing positions. FIG. 5A, FIG. 5B, FIG. 5C, FIG. 5D and FIG. 5E shows for illustrative purposes only various views of one example of a portable USB mini-charger AC device configuration of one embodiment of the present invention.

FIG. 5A shows for illustrative purposes only an example of a portable USB mini-charger AC device from an outlet blade extended end view of one embodiment of the present invention. FIG. 5A shows the portable USB mini-charger device 100 of FIG. 1 configured to include the power source connection 110 of FIG. 1 configured to connect to a 120 volt AC outlet power source 200 of FIG. 2 such as a standard home or office electrical outlet or a vehicle inverter outlet to create a portable USB mini-charger AC device 500. The portable USB mini-charger AC device 500 is configured to include the current inverter 130 of FIG. 1 and the voltage regulation 120 system of FIG. 1. The portable USB mini-charger AC device 500 is configured to include two folding outlet blade 510 elements to make the connection to the 120 volt AC outlet. Each folding outlet blade 510 is connected to the body of the portable USB mini-charger AC device 500 using an outlet blade hinge 520. The outlet blade hinge 520 connection allows the two folding outlet blade 510 elements to be folded toward the body into their respective folding outlet blade recess 530 below the surface of a power source connection face plate 535 of one embodiment of the present invention.

FIG. 5B shows for illustrative purposes only an example of a portable USB mini-charger AC device from a USB receptacle end view of one embodiment of the present invention. FIG. 5B shows the portable USB mini-charger AC device 500 configured to include the USB receptacle 140 of FIG. 1 positioned at the surface of a USB receptacle AC face plate 540 to allow easy access to make a connection to an electronic device 220 of FIG. 2 of one embodiment of the present invention.

FIG. 5C shows for illustrative purposes only an example of a portable USB mini-charger AC device from a bottom view of one embodiment of the present invention. FIG. 5C shows the portable USB mini-charger AC device 500 with each folding outlet blade 510 folded up from the folding outlet blade recess 530 of FIG. 5A using the outlet blade hinge 520 as the pivot point of one embodiment of the present invention.

FIG. 5D shows for illustrative purposes only an example of a portable USB mini-charger AC device hinged outlet blade operation from a side view of one embodiment of the present invention. FIG. 5D shows the portable USB mini-charger AC device 500 and the path of the folding outlet blade 510 being folded in an arc path pivoting upon the outlet blade hinge 520. The folding outlet blade recess 530 has space for the folded position of the folding outlet blade 550 to be below the surface of a power source connection face plate 535 of one embodiment of the present invention.

FIG. 5E shows for illustrative purposes only an example of a portable USB mini-charger AC device in a prospective view of one embodiment of the present invention. FIG. 5E shows the physical relationship of the elements of the portable USB mini-charger AC device 500 including the two folding outlet blade 510 elements, the USB receptacle 140 easily accessible on the USB receptacle AC face plate 540 of one embodiment of the present invention.

### Multi-Hub Adapter:

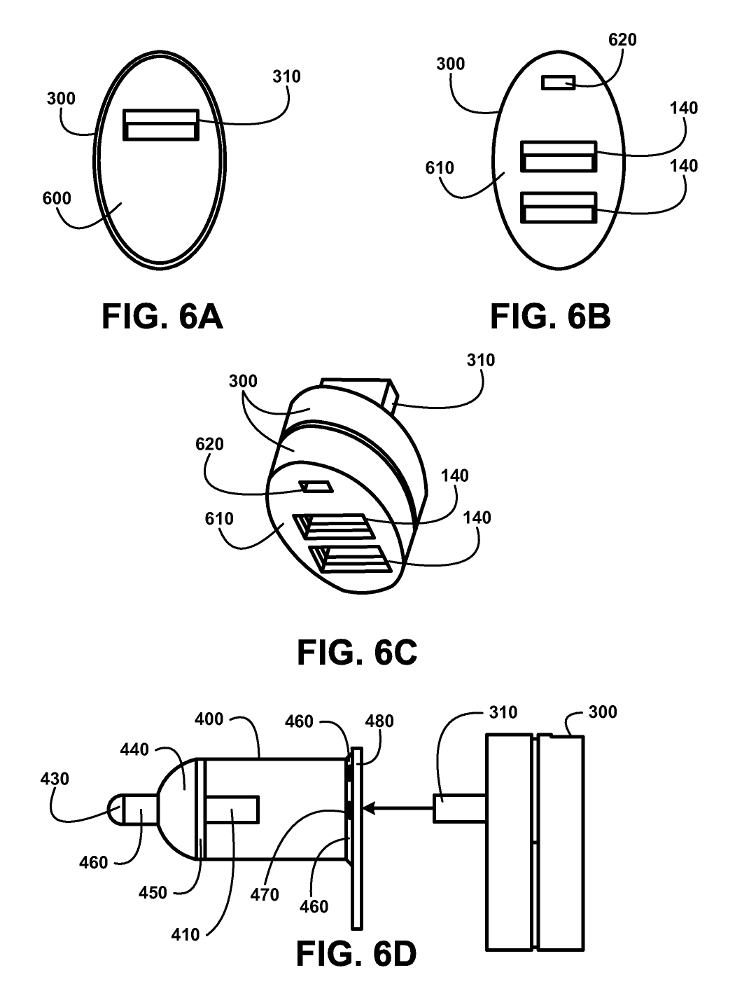

The portable USB mini-charger DC device can be configured to include various components to provide additional capabilities. FIG. 6A, FIG. 6B, FIG. 6C and FIG. 6D shows for illustrative purposes only various views of one example of a portable USB mini-charger device multi-hub adapter. The portable USB mini-charger device 100 of FIG. 1 can be configured to include a multi-hub adapter 300 component of one embodiment of the present invention.

FIG. 6A shows for illustrative purposes only an example of a portable USB mini-charger device multi-hub adapter from a USB plug end view of one embodiment of the present invention. FIG. 6A shows the multi-hub adapter 300 configured to include the USB plug 310 connected through a USB plug adapter face plate 600. The multi-hub adapter 300 can be configured to include different types of USB connector plugs such as Standard-A, Standard-B, Mini-A, Mini-B, Micro-A and Micro-B of one embodiment of the present invention.

FIG. 6B shows for illustrative purposes only an example of a portable USB mini-charger device multi-hub adapter from a USB receptacle end view of one embodiment of the present invention. FIG. 6B shows multi-hub adapter 300 configured to include two USB receptacle 140 elements connected through a USB receptacle adapter face plate 610. The USB receptacle adapter face plate 610 is configured to include an adapter power indicator light 620 to light when a current connection has been completed. The multi-hub adapter 300 can be configured to include different types of USB connector receptacles such as Standard-A, Standard-B, Mini-A, Mini-B, Micro-A and Micro-B view of one embodiment of the present invention.

FIG. 6C shows for illustrative purposes only an example of a portable USB mini-charger device multi-hub adapter in a prospective view of one embodiment of the present invention. FIG. 6C shows the relationship of the elements included in the multi-hub adapter 300 including the USB plug 310, the USB receptacle adapter face plate 610 positioned on the opposite end and the two USB receptacle 140 elements and the adapter power indicator light 620 connected through the USB receptacle adapter face plate 610 of one embodiment of the present invention.

FIG. 6D shows for illustrative purposes only an example of a portable USB mini-charger DC device and a multi-hub adapter connection operation from a side view of one embodiment of the present invention. FIG. 6D shows the portable USB mini-charger DC device 400 configured to include the contact 430, the insulated contact support 460, the plug insertion guide 440, the insulating gasket 450, the spring 410, the insulated contact support 460, the insulated air gap 470 and the USB receptacle DC face plate 480. Connected through the USB receptacle DC face plate 480 is the USB receptacle 140 of FIG. 1. The multi-hub adapter 300 is configured with the USB plug 310. The USB plug 310 is inserted into the USB receptacle 140 of FIG. 1 accessed through the USB receptacle DC face plate 480 to complete the electrical connection through the portable USB mini-charger DC device 400 to the power source 200 of FIG. 2 of one embodiment of the present invention.

The multi-hub adapter 300 component increases the number of USB receptacle 140 of FIG. 1 elements of the portable USB mini-charger device 100 of FIG. 1. The increased number of receptacles increases the number of USB connection powered electronic devices or their component elements that can operate or recharge internal batteries at the same time. The ability to use the portable USB mini-charger device 100 of FIG. 1 from any readily available power source 200 of FIG. 2 whether the power source 200 of FIG. 2 provides DC or AC electrical current to power one or more electronic device 220 of FIG. 2 enables the user to maintain the portability and mobility inherent in the use of portable electronic devices of one embodiment of the present invention.

### Portable USB Mini-Charger AC Two USB Port Device:

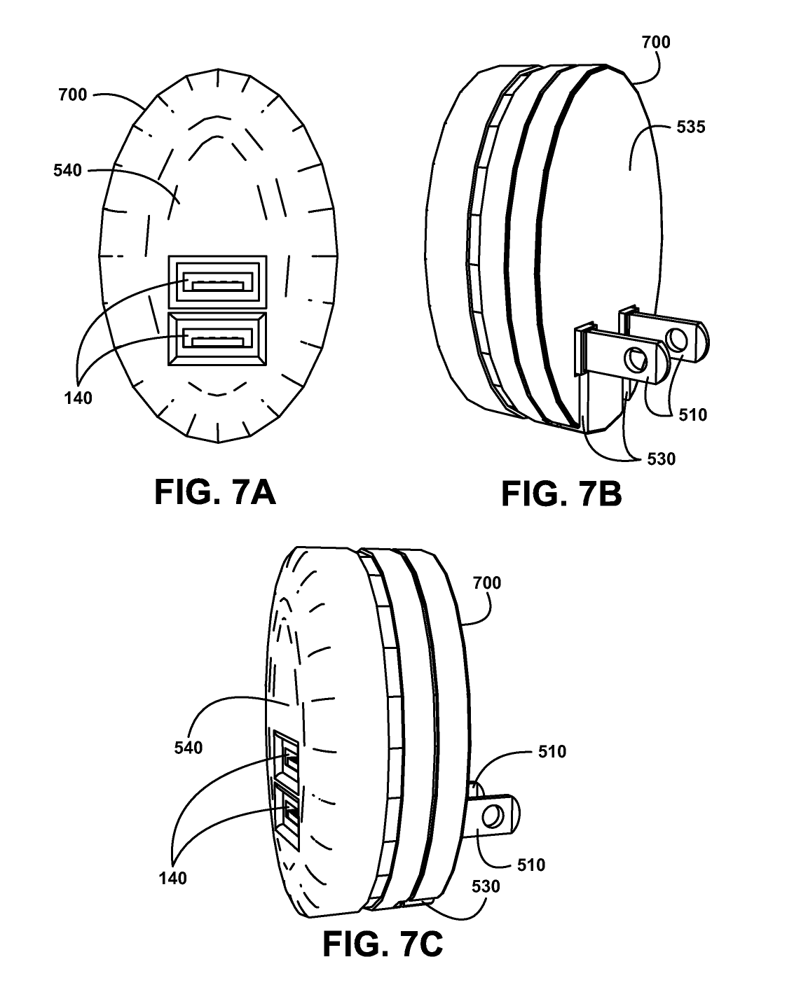

The portable USB mini-charger AC device can be configured to include two USB receptacles. FIGS. 7A, 7B and 7C shows for illustrative purposes only various views of one example of a portable USB mini-charger AC device configured to include two USB receptacles of one embodiment of the present invention. FIG. 7A shows for illustrative purposes only an example of a portable USB mini-charger AC two USB port device font view of one embodiment of the present invention. FIG. 7A shows a portable USB mini-charger AC two USB port device 700 that can be configured with two USB receptacle 140 ports. The two USB receptacle 140 ports can be positioned at the surface of a USB receptacle AC face plate 540 to allow easy access to make a connection to an electronic device 220 of FIG. 2 of one embodiment of the present invention.

FIG. 7B shows for illustrative purposes only an example of a portable USB mini-charger AC two USB port device back prospective view of one embodiment of the present invention. FIG. 7B shows the portable USB mini-charger AC two USB port device 700 configured with the power source connection 110 of FIG. 1 configured with two folding outlet blade 510 connectors. The folding outlet blade recess 530 has space for the folded position of each folding outlet blade 510 to be below the surface of a power source connection face plate 535 of one embodiment of the present invention.

FIG. 7C shows for illustrative purposes only an example of a portable USB mini-charger AC two USB port device right side prospective view of one embodiment of the present invention. FIG. 7C shows the portable USB mini-charger AC two USB port device 700 configured with the two folding outlet blade 510 connectors folded up and for example extended for use in plugging into a standard house electrical outlet. The folding outlet blade recess 530 forms a space below the surface of the power source connection face plate 535 to accept each folding outlet blade 510 when folded down. The two USB receptacle 140 ports positioned on the USB receptacle AC face plate 540 allows a user to plug-in a device using a USB connection to charge the device of one embodiment of the present invention.

### Mini Charger AC Device Different AC Plug Types:

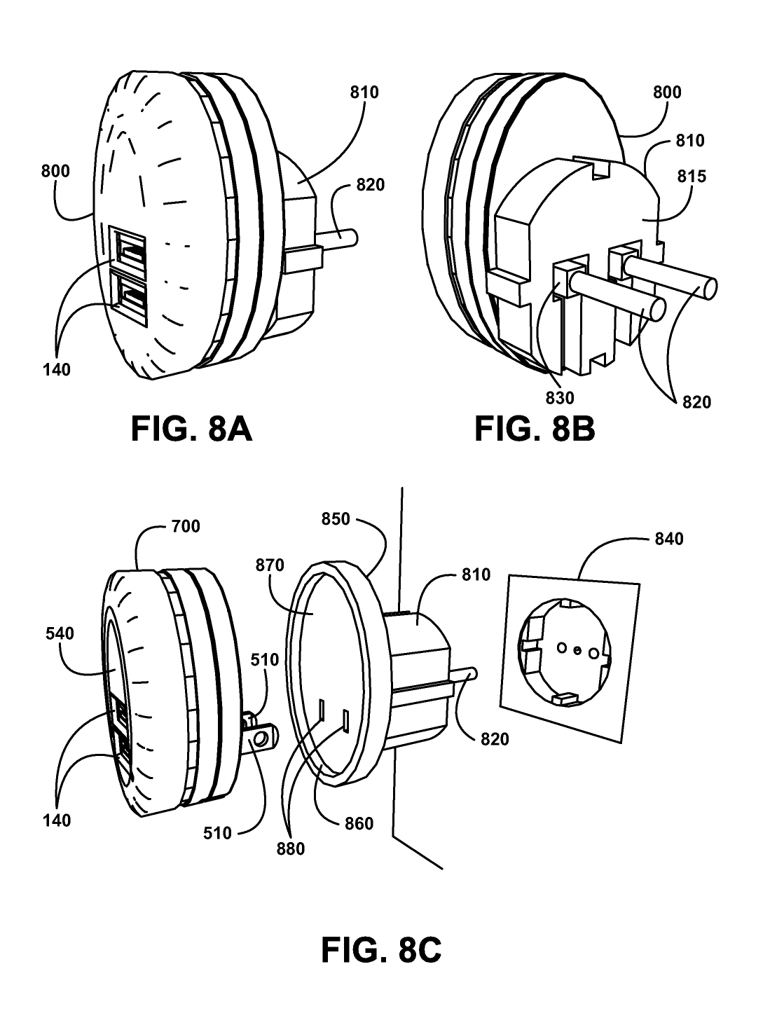

The portable USB mini-charger AC device 100 of FIG. 1 can be fabricated in various configurations using different components adapting to differing electrical service standards and using different power source connection 110 of FIG. 1 types such as the various types used around the world. FIG. 8A and FIG. 8B shows for illustrative purposes only two perspective views of one example of a portable USB mini-charger AC device 100 of FIG. 1 configured to include a hinged pin plug type power source connection 110 of FIG. 1 and capable of connecting to a different electrical service standard than the 120 volt AC current blade outlet described in FIG. 1 and the General Overview. The portable USB mini-charger AC device 100 of FIG. 1 can be configured to match any electrical service standards and power source connection 110 of FIG. 1 type of one embodiment of the present invention.

FIG. 8A shows for illustrative purposes only an example of a portable USB mini charger AC device hinged pin plug type in a front USB prospective view of one embodiment of the present invention. FIG. 8A shows a portable USB mini charger AC device hinged pin plug type 800 in a perspective view that shows the two USB receptacle 140 connections. The portable USB mini charger AC device hinged pin plug type 800 can be configured to include on the back side for example a Type F Two Pin Ungrounded Plug Base 810 and shows one of the two folding pin plug 820 connectors. The voltage regulation 120 of FIG. 1 equipment installed inside the portable USB mini charger AC device hinged pin plug type 800 can be configured to regulate the electric current available to the match the standards in a geographic area to adjust the voltage and frequencies for example 50 Hz and 60 Hz of one embodiment of the present invention.

FIG. 8B shows for illustrative purposes only an example of a portable USB mini charger AC device hinged pin plug type in a back hinged pin plug prospective view of one embodiment of the present invention. FIG. 8B shows a perspective view of the back of the portable USB mini charger AC device hinged pin plug type 800 configured with the Type F Two Pin Ungrounded Plug Base 810. The Type F Two Pin Ungrounded Plug Base 810 can be configured with two folding pin plug 820 connectors. The folding pin plug 820 connectors are hinged to allow the pins to be folded into the base recesses below the surface of the Type F power source connection face plate 815 for convenient storage of one embodiment of the present invention.

### Mini Charger AC Device Adapter:

FIG. 8C shows for illustrative purposes only an example of a portable USB mini charger AC device hinged pin plug type adapter in a prospective view of one embodiment of the present invention. The portable USB mini-charger AC device 100 of FIG. 1 can be configured for various electrical service standards and connection equipment types customarily found in a geographic area or region. A person traveling may desire to be able to use their portable USB mini-charger AC device 100 of FIG. 1 in another geographic area or region that has different electrical service standards and connection equipment types. The portable USB mini-charger AC device 100 of FIG. 1 can be configured to include various adapters to have the capability to connect to other regional electrical service standards and connection equipment types of one embodiment of the present invention.

FIG. 8C shows one example of the portable USB mini-charger AC device 100 of FIG. 1 configured to operate in one regional electric standard and an adapter to allow connection and use in another different regional electric standard that include different connection equipment types of one embodiment of the present invention. FIG. 8C shows the portable USB mini-charger AC two USB port device 700 configured with the folding outlet blade 510 plug connections. This would typically be used for example with electrical standards that are characterized by 120 volts and 60 Hz. The portable USB mini-charger AC two USB port device 700 can be configured with voltage regulation 120 of FIG. 1 equipment and an AC to DC current inverter 130 of FIG. 1 to supply DC voltage to the two USB receptacle 140 connections on the USB receptacle AC face plate 540 of one embodiment of the present invention.

FIG. 8C shows one example of a portable USB mini charger AC device adapter 850 folding pin plug type configured for example with the Type F Two Pin Ungrounded Plug Base 810. The Type F Two Pin Ungrounded Plug Base 810 can be configured with two folding pin plug 820 connectors. The portable USB mini charger AC device adapter 850 can be configured with the Type F Two Pin Ungrounded Plug Base 810 and two folding pin plug 820 connectors. The folding pin plug 820 connectors are hinged to allow the pins to be folded into the portable USB mini charger AC device adapter 850 base recesses below the surface of the Type F power source connection face plate 815 of FIG. 8B for convenient storage. The exampled base and two pins allow the adapter to plug into a Type F Two Pin Ungrounded outlet for example a type used in regions of Europe and commonly called a Europlug outlet. The Europlug outlets can be configured to supply dual voltages for example 125 volts and 250 volts at 50 Hz which can be switched back and forth at the outlet of one embodiment of the present invention.

The portable USB mini charger AC device adapter 850 can be configured to include voltage regulation 120 of FIG. 1 installed in the body of the adapter to convert the current being supplied in the example 125 volts at 50 Hz to the 120 volts at 60 Hz voltage configured in the exampled portable USB mini-charger AC two USB port device 700. The exampled portable USB mini-charger AC two USB port device 700 would complete the voltage regulation 120 of FIG. 1 and AC to DC current inverter 130 of FIG. 1 conversion to supply DC voltage to the two USB receptacle 140 connections on the front side of one embodiment of the present invention.

The portable USB mini charger AC device adapter 850 can be configured to include opposite its power source connection 110 of FIG. 1 a recessed adapter end to allow the adapter to attach to the portable USB mini-charger AC device 100 of FIG. 1. The recessed adapter end is configured to include an adapter face plate 870 to match the size and shape of the power source connection face plate 535 of FIG. 5A of the portable USB mini-charger AC two USB port device 700. The adapter face plate 870 can be configured with a perimeter extension 860 configured to align and secure in position the portable USB mini charger AC device adapter 850 to the portable USB mini-charger AC device 100 of FIG. 1. The portable USB mini charger AC device adapter 850 can be configured with corresponding power source connection 110 of FIG. 1 receptacles allowing insertion of the power source connection 110 of FIG. 1 of the portable USB mini-charger AC device 100 of FIG. 1. The corresponding power source connection 110 of FIG. 1 receptacles can be configured to include receiving openings positioned on the adapter face plate 870 of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A portable USB mini-charger device to supply electric power to a portable electronic device from readily available power sources, comprising:
a first charger device having a male connector on one end configured to receive power from a female DC power source and a having a female USB port on another end configured to receive a male USB connection;
a second charger device having retractable male connectors on one end configured to receive power from a female AC power source and a having a female USB port on another end configured to receive a male USB connection;
an adapter with a male USB connection on one end configured to interchangeably couple between the first and second charger power sources depending on the type of power source available to a user;
wherein the adapter couples with flush side edges when connected to the first and the second charger devices and wherein adapter includes multiple female USB ports on another end of the adapter; and
a universal voltage adapter have one end with female connectors configured to be removeably coupled to the retractable male connectors of the second charger device and retractable male connectors on another end configured to be connected to different voltage rated power sources.

2. The portable USB mini-charger device of claim 1, wherein the DC power source is a 12 volt cigarette lighter connector of a vehicle electrical system.

3. The portable USB mini-charger device of claim 1, wherein the AC power source is a 120 volt electrical outlet.

4. The portable USB mini-charger device of claim 1, wherein the universal voltage adapter is configured to connect to 240 volt electrical outlet.

5. The portable USB mini-charger device of claim 1, further including a voltage regulation system.

6. The portable USB mini-charger device of claim 5, wherein the voltage regulation system is configured to include equipment to regulate power supplied through an electrical outlet at various voltages and frequencies of different AC electricity service standards.

7. The portable USB mini-charger device of claim 1, further includes a recessed adapter end.

8. The portable USB mini-charger device of claim 1, wherein the USB receptacle is configured to include different types of USB connector receptacles including at least one of Standard-A, Standard-B, Mini-A, Mini-B, Micro-A and Micro-B.

9. The portable USB mini-charger device of claim 1, wherein the adapter includes a power indicator light.

10. The portable USB mini-charger device of claim 9, wherein the power indicator light turns on when an electrical connection is completed.

11. The portable USB mini-charger device of claim 9, wherein the power indicator light changes color when the device connected to the portable USB mini-charger device is fully charged or is rejecting a charge.

12. A portable USB mini-charger device to supply electric power to a portable electronic device from readily available power sources, comprising:
a first charger device having a male connector on one end configured to receive power from a female 12 volt direct current cigarette lighter power source of a vehicle and a having a female USB port on another end configured to receive a male USB connection;
a second charger device having retractable male connectors on one end configured to receive power from a female 120 volt alternating current power source and a having a female USB port on another end configured to receive a male USB connection;
an adapter with a male USB connection on one end configured to interchangeably couple between the first and second charger power sources depending on the type of power source available to a user;
wherein the adapter couples with flush side edges when connected to the first and the second charger devices and wherein adapter includes multiple female USB ports on another end of the adapter; and
a universal voltage adapter have one end with female connectors configured to be removeably coupled to the retractable male connectors of the second charger device and retractable male connectors on another end configured to be connected to different voltage rated power sources.

13. The portable USB mini-charger device of claim 12, wherein the universal voltage adapter is configured to connect to 240 volt electrical outlet.

14. The portable USB mini-charger device of claim 12, further including a voltage regulation system.

15. The portable USB mini-charger device of claim 14, wherein the voltage regulation system is configured to include equipment to regulate power supplied through an electrical outlet at various voltages and frequencies of different AC electricity service standards.

16. The portable USB mini-charger device of claim 12, further includes a recessed adapter end.

17. The portable USB mini-charger device of claim 12, wherein the USB receptacle is configured to include different types of USB connector receptacles including at least one of Standard-A, Standard-B, Mini-A, Mini-B, Micro-A and Micro-B.

18. The portable USB mini-charger device of claim 12, wherein the adapter includes a power indicator light.

19. The portable USB mini-charger device of claim 18, wherein the power indicator light turns on when an electrical connection is completed.

20. A portable USB mini-charger device to supply electric power to a portable electronic device from readily available power sources, comprising:
a first charger device having a male connector on one end configured to receive power from a female 12 volt direct current cigarette lighter power source of a vehicle and a having a female USB port on another end configured to receive a male USB connection;
a second charger device having retractable male connectors on one end configured to receive power from a female 120 volt alternating current power source and a having a female USB port on another end configured to receive a male USB connection;
an adapter with a male USB connection on one end configured to interchangeably couple between the first and second charger power sources depending on the type of power source available to a user;
wherein the adapter couples with flush side edges when connected to the first and the second charger devices and wherein adapter includes multiple female USB ports on another end of the adapter;
a universal voltage adapter have one end with female connectors configured to be removeably coupled to the retractable male connectors of the second charger device and retractable male connectors on another end configured to be connected to different voltage rated power sources; and
a power indicator light, wherein the power indicator light turns on when an electrical connection is completed.
